(19) United States
(12) Patent Application Publication
(10) Pub. No.: US 2026/0084693 A1
(43) Pub. Date: Mar. 26, 2026

(54) PARKING SUPPORT APPARATUS

(71) Applicant: TOYOTA JIDOSHA KABUSHIKI KAISHA, Toyota-shi (JP)

(72) Inventors: Takuya Nakagawa, Okazaki-shi (JP); Tomohito Higuma, Toyota-shi (JP); Tatsuya Ishiguro, Toyota-shi (JP)

(73) Assignee: TOYOTA JIDOSHA KABUSHIKI KAISHA, Toyota-shi (JP)

(21) Appl. No.: 19/280,536

(22) Filed: Jul. 25, 2025

(30) Foreign Application Priority Data
Sep. 25, 2024 (JP) 2024-166330

(51) Int. Cl. B60W 30/06; B60W 50/14

(52) U.S. Cl. CPC B60W 30/06; B60W 50/14; B60W 2520/10; B60W 2554/20; B60W 2720/106

(57) ABSTRACT

A parking support apparatus is configured to execute a parking support control for parking a vehicle in a parking space. The parking support apparatus is configured to allow the parking support control to be executed, in response to a position of the vehicle satisfying a start position condition and a vehicle speed being equal to or lower than a predetermined start speed, and start a deceleration notification that notifies a user that the parking support control becomes available by decelerating the vehicle, in response to the position of the vehicle satisfying the start position condition and the vehicle speed being higher than the start speed.

### TECHNICAL FIELD

The present disclosure relates to a parking support apparatus configured to execute a parking support control for parking a vehicle in a parking space.

### BACKGROUND

Conventionally, a parking support apparatus has been known which is configured to execute, as a parking support control, an automatic parking control for automatically parking a vehicle in a parking space by automatically driving the vehicle along a pre-registered parking route. For example, a parking support apparatus described in Patent Document 1 (hereinafter referred to as a “conventional apparatus”) notifies a driver (user) of a start position from which the automatic parking control can be started.
Patent Document 1: Japanese Patent Application Laid-Open No. 2022-133230

### SUMMARY

A parking support apparatus has been considered, which is configured not to start the parking support control when a vehicle speed representing a speed of the vehicle is higher than a predetermined start speed, and to start the parking support control when the vehicle speed is equal to or lower than the start speed.

When the parking support control is not started due to the vehicle speed being higher than the start speed, the conventional apparatus cannot notify the driver of this fact. In other words, the conventional apparatus cannot notify the driver that the parking support control can become available when the vehicle is decelerated. As a result, the conventional apparatus may lose an opportunity to execute the parking support control.

The present disclosure is made to address the above problem. That is, one of the objects of the present disclosure is to provide the parking support apparatus that reduces a probability that an opportunity to execute the parking support control is lost, by notifying the driver that the parking support control becomes available by decelerating the vehicle.

A parking support apparatus according to the present disclosure (hereinafter, referred to as “the present disclosure apparatus”) is configured to execute a parking support control for parking a vehicle (VA) in a parking space (PS) (steps 700 through 795).

The parking support apparatus is configured to:
allow the parking support control to be executed (step 428), in response to a position of the vehicle satisfying a start position condition (“Yes” at step 402, “Yes” at step 404) and a vehicle speed being equal to or lower than a predetermined start speed (Vst) (“Yes” at step 412); and
start a deceleration notification that notifies a user that the parking support control becomes available by decelerating the vehicle (step 416, step 418), in response to the position of the vehicle satisfying the start position condition (“Yes” at step 402, “Yes” at step 404) and the vehicle speed being higher than the start speed (“No” at step 412).

When the vehicle speed is higher than the start speed, the parking support control is not available even if the position of the vehicle satisfies the start position condition. The present disclosure apparatus starts the deceleration notification that notifies the user that the parking support control becomes available by decelerating the vehicle (decelerating the vehicle enables the parking support control), when the vehicle speed is higher than the start speed. Accordingly, the user can recognize that the parking support control becomes available by decelerating the vehicle. Therefore, the present disclosure apparatus can reduce the probability that the opportunity to execute the parking support control is lost.

In one aspect of the present disclosure apparatus,
the present disclosure apparatus is configured to start an availability notification that notifies the user that the parking support control is available (step 422, step 428), in response to the position of the vehicle satisfying the start position condition (“Yes” at step 402, “Yes” at step 404) and the vehicle speed being equal to or lower than the start speed (“No” at step 412).

The present disclosure apparatus starts the availability notification that notifies the user that the parking support control is available, when the parking support control is available. Accordingly, the user can recognize that the parking support control is available, and therefore, the present disclosure apparatus can reduce the probability that the opportunity to execute the parking support control is lost.

In one aspect of the present disclosure apparatus,
the parking support apparatus is configured to:
determine whether or not the vehicle speed is equal to or lower than a start upper-limit speed that is greater than the start speed (step 414), in response to the position of the vehicle satisfying the start position condition (“Yes” at step 402, “Yes” at step 404) and the vehicle speed being higher than the start speed (“No” at step 412);
start the deceleration notification (step 416, step 418) in response to the vehicle speed being equal to or lower than the start upper-limit speed (“Yes” at step 414);
not start the deceleration notification in response to the vehicle speed being higher than the start upper-limit speed (“No” at step 414); and
end the deceleration notification (step 430) in response to the vehicle speed becoming equal to or higher than a first end speed (Ved1) that is higher than the start upper-limit speed (“No” at step 422) after the deceleration notification has been started (“Yes” at step 420).

When the vehicle speed is higher than the start upper-limit speed even though the position of the vehicle satisfies the start position condition, it is likely that the driver does not intend to use the parking support control. If the deceleration notification is performed despite the driver having no such intention, the driver is likely to feel annoyed by the deceleration notification. The present disclosure apparatus is configured not to start the deceleration notification when the vehicle speed is higher than the start upper-limit speed. This can reduce a probability that the driver feels annoyed by the deceleration notification.

When the vehicle speed becomes equal to or higher than the first end speed after the deceleration notification has been started, it is likely that the driver no longer intends to use the parking support control. Since the present disclosure apparatus is configured to end the deceleration notification in response to the vehicle speed becoming equal to or higher than the first end speed, it can reduce the probability that the driver feels annoyed by the deceleration notification.

If the first end speed is set to be the same as the start upper-limit speed, it is likely that the deceleration notification repeatedly starts and ends while the vehicle is traveling near a speed set as both the first end speed and the start upper-limit speed. The driver is likely to feel annoyed by such repeated deceleration notification. Since the first end speed is set to be higher than the start upper-limit speed, the present disclosure apparatus can reduce a probability that the deceleration notification repeatedly starts and ends. Accordingly, it can reduce the probability that the driver feels annoyed by the deceleration notification.

In the aspect,
the present disclosure apparatus is configured to execute, as the parking support control, an automatic parking control for automatically driving the vehicle to park the vehicle in the parking space such that the vehicle speed does not exceed an upper-limit control speed (Vlmt) (step 745). The start speed is set to the upper-limit control speed.

It is possible to reduce the possibility that the availability notification is performed even though the vehicle speed is higher than the upper-limit control speed of the automatic parking control.

In one aspect of the present disclosure apparatus,
the present disclosure apparatus is configured to:
start, as the parking support control, an automatic parking control for automatically driving the vehicle to park the vehicle in the parking space such that the vehicle speed does not exceed an upper-limit control speed (Vlmt), in response to a predetermined start operation being performed by the user (“Yes” at step 715) while the availability notification is being performed; and
end the availability notification (step 436) in response to the vehicle speed becoming equal to or higher than a second end speed (Ved2) that is higher than the start speed (“No” at step 434).

The second end speed is set to the upper-limit control speed.

When the vehicle speed becomes equal to or higher than the second end speed set to the upper-limit control speed after the availability notification has been started, the availability notification is ended. Once the availability notification is ended, the automatic parking control is not started. Therefore, the present disclosure apparatus can prevent the automatic parking control from being started when the vehicle speed is equal to or higher than the upper-limit control speed.

In one aspect of the present disclosure apparatus,
the present disclosure apparatus is configured to:
store, as a learning parking route (Rpa), a route that the vehicle traveled along when the vehicle was parked in the parking space by manual driving (step 345);
execute, as the parking support control, an automatic parking control for automatically driving the vehicle along the learning parking route to park the vehicle in the parking space (step 745); and
determine that the position of the vehicle satisfies the start position condition in response to a distance (D) between the vehicle and the learning parking route being equal to or shorter than a threshold distance (Dth) (“Yes” at step 402).

The present disclosure apparatus can notify the user that the automatic parking control is not available because the vehicle speed is higher than the start speed, even though the vehicle is located near the learning parking route. Therefore, the present disclosure apparatus can reduce the probability that the opportunity to execute the automatic parking control is lost.

In one aspect of the present disclosure apparatus,
the present disclosure apparatus is configured to
execute, as the parking support control, an automatic parking control for automatically driving the vehicle to park the vehicle in the parking space; and
start the deceleration notification (step 418) in response to:
   the position of the vehicle satisfying the start position condition (“Yes” at step 402),
   the vehicle speed being higher than the start speed (“No” at step 412), and
   there being no contact object that may come into contact with the vehicle on a planned route along which the vehicle is to travel in order to park in the parking space (“No” at step 408).

If the automatic parking control is executed when there is the contact object, the vehicle may come into contact with the contact object. Therefore, the automatic parking control is not executed when there is the contact object. In a case where the deceleration notification is performed when there is the contact object, the automatic parking control is not executed even if the user decelerates the vehicle. Such a deceleration notification is likely to cause discomfort to the user. The present disclosure apparatus performs the deceleration notification when there is no contact object and the vehicle speed is higher than the start speed. Accordingly, the present disclosure apparatus can reduce a probability that the user feels discomfort due to the deceleration notification being performed even though the automatic parking control will not be started.

In the above description, for ease of understanding, reference numerals used in the embodiment of the present disclosure are enclosed in parentheses and assigned to respective components corresponding to the features of the present disclosure. However, the features of the present disclosure are not limited to the embodiment as indicated by the reference numerals. Other objects, features, and advantages of the present disclosure will become more apparent from the following description of the embodiments with reference to the accompanying drawings.

### BRIEF DESCRIPTION OF THE DRAWINGS

FIG. 1 is a schematic system configuration diagram of a parking support apparatus to an embodiment of the present disclosure.

FIG. 2 is an explanatory diagram illustrating an outline of an operation of the parking support apparatus according to the embodiment of the present disclosure.

FIG. 3 is a flowchart illustrating a parking route learning routine executed by a CPU of an ECU shown in FIG. 1.

FIG. 4 is a flowchart illustrating a part of a notification routine executed by the CPU of the ECU shown in FIG. 1.

FIG. 5 is a flowchart illustrating a remaining part of the notification routine executed by the CPU of the ECU shown in FIG. 1.

FIG. 6 is a diagram illustrating a relationship between a deceleration notification and a vehicle speed, and a relationship between an availability notification and the vehicle speed.

FIG. 7 is a flowchart illustrating an automatic parking control routine executed by the CPU of the ECU shown in FIG. 1.

### DETAILED DESCRIPTION

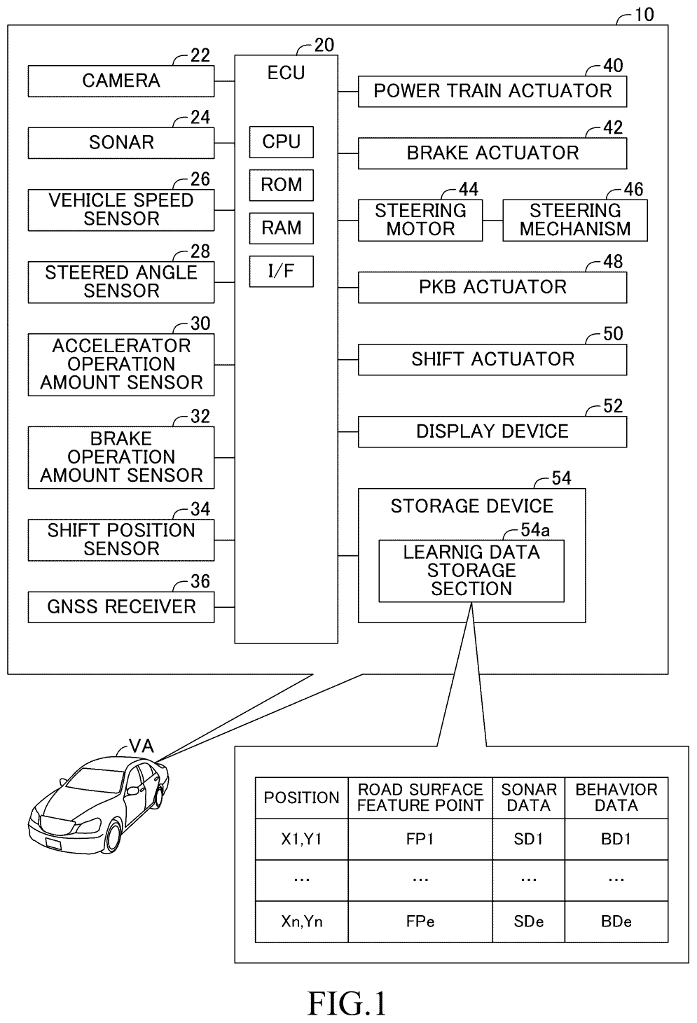

As shown in FIG. 1, a parking support apparatus (hereinafter, referred to as “the present apparatus 10”) according to the present embodiment is applied to a vehicle VA. The present apparatus 10 comprises the components shown in FIG. 1. In this specification, an “ECU 20” is an electronic control unit having a microcomputer as a main component. The ECU 20 is also referred to as a control unit, a controller and a computer. The microcomputer includes a CPU (processor), a ROM, a RAM and an interface (I/F), etc. Functions realized by the ECU 20 may be realized by multiple ECUs.

A camera 22 acquires image data by capturing an image of an environment around the vehicle VA. The ECU 20 obtains the image data from the camera 22. A sonar 24 acquires point cloud data as sonar data by scanning the environment around the vehicle VA. The point cloud data includes a plurality of points, each of which represents a position, relative to the vehicle VA, of a part of a three-dimensional object that reflects sound waves. The ECU 20 obtains the sonar data from the sonar 24.

A vehicle speed sensor 26 measures a vehicle speed Vs representing a speed of the vehicle VA. A steered angle sensor 28 measures a steered angle θ of steered wheels of the vehicle VA. An accelerator operation amount sensor 30 measures an accelerator operation amount AP representing an amount of operation (depression) of an accelerator pedal (not shown) of the vehicle VA. A brake operation amount sensor 32 measures a brake operation amount BP representing an amount of operation (depression) of a brake pedal (not shown) of the vehicle VA. The ECU 20 obtains measurement values from these sensors 26 to 32.

A shift position sensor 34 detects a shift position SP of a shift lever (not shown) of the vehicle VA. A driver (user) of the vehicle VA can set the shift lever to any one of a drive position (D range), a reverse position (R range), a neutral position (N range), or a parking position (P range). The ECU 20 identifies the shift position SP based on a detection value from the shift position sensor 34. The ECU 20 obtains the detection value from the shift position sensor 34.

A GNSS (Global Navigation Satellite System) receiver 36 receives signals from a plurality of satellites and identifies a current position (latitude and longitude) of the vehicle VA based on the received signals.

A power train actuator 40 changes a driving force generated by a driving device (e.g., an internal combustion engine and/or an electric motor) of the vehicle VA. A brake actuator 42 changes a braking force applied to the vehicle VA. A steering motor 44 is installed in a steering mechanism 46. The steering mechanism 46 is a mechanism for turning the steered wheels in accordance with an operation of a steering wheel. The steering motor 44 generates an automatic steering torque to change the steered angle of the steered wheels of the vehicle VA in accordance with an instruction from the ECU 20.

A PKB actuator 48 applies a parking brake force to wheels. By applying the parking brake force to the wheels, the vehicle VA can maintain a stopped state. A shift actuator 50 can change a set position SP of a shift lever in accordance with an instruction from an ECU 20.

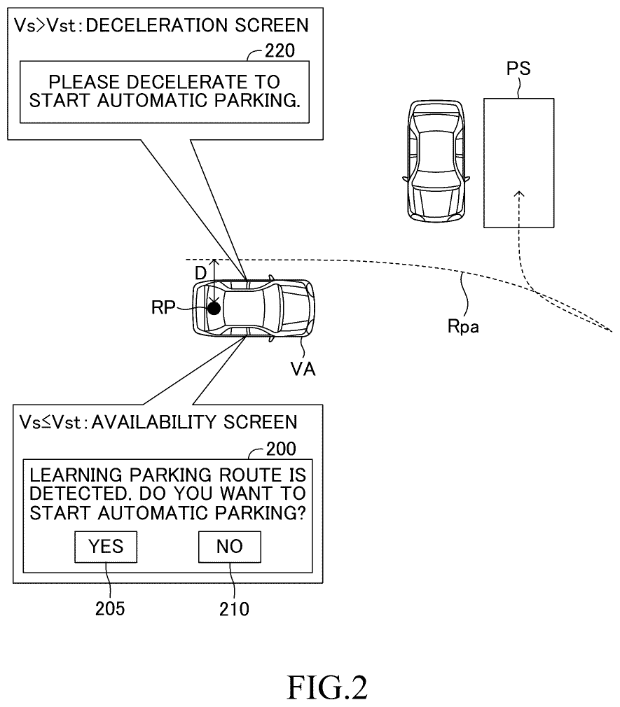

A display device 52 is disposed at a position in a cabin of a vehicle VA such that the driver can visually recognize it. For example, the display device 52 is a touch-panel type display. The display device 52 displays an availability screen 200 or a deceleration screen 220 shown in FIG. 2. A storage device 54 includes a non-volatile storage area. In this storage area, a learning data storage section 54a is provided. Learning data described later is stored in the learning data storage section 54a.

### <Parking Support Control>

The ECU 20 executes a parking support control for parking the vehicle VA in a parking space PS (see FIG. 2). As one example of the parking support control, there is an automatic parking control. In the automatic parking control, the vehicle VA automatically travels to and parks in the parking space PS.

The automatic parking control executed by the ECU 20 as the parking support control in the present embodiment is described. First, the driver performs a teaching drive. In the teaching drive, the driver manually drives the vehicle VA in order to park the vehicle VA in the parking space PS. The ECU 20 stores, as the learning data in the learning data storage section 54a, a parking route Rpa (see FIG. 2) along which the vehicle VA travels during the teaching drive, and behavior of the vehicle VA during the teaching drive. The parking route Rpa may also be referred to as a “learning parking route Rpa”.

After the teaching drive, when the vehicle VA is located in the vicinity of the learning parking route Rpa and the vehicle speed Vs is equal to or lower than a start speed Vst, the ECU 20 executes the automatic parking control based on the learning data. Specifically, the ECU 20 controls the vehicle VA so as to reproduce the behavior learned during the teaching drive, thereby causing the vehicle VA to travel along the learning parking route Rpa and park in the parking space PS. Such automatic parking control is a type of autonomous driving.

### (Outline of Operation)

When the position of the vehicle VA satisfies a predetermined start position condition and when the vehicle speed Vs is equal to or lower than the start speed Vst, the ECU 20 allows the automatic parking control to be executed (i.e., the automatic parking control becomes available). When a distance D (see FIG. 2) between the vehicle VA and the learning parking route Rpa is equal to or shorter than a threshold distance Dth, the ECU 20 determines that the position of the vehicle VA satisfies the start position condition. More specifically, the distance D is a distance between a reference point RP (see FIG. 2), which is set at a midpoint between a right rear wheel and a left rear wheel of the vehicle VA, and the learning parking route Rpa.

When the ECU 20 determines that the position of the vehicle VA satisfies the start position condition, the ECU 20 determines whether or not the vehicle speed Vs is equal to or lower than the start speed Vst. When the vehicle speed Vs is equal to or lower than the start speed Vst, the ECU 20 performs an availability notification to notify (inform) the driver that the automatic parking control is available. For example, the ECU 20 displays an availability screen 200 on the display device 52. On the availability screen 200, a message such as “Learning parking route is detected. Do you want to start automatic parking?”, a YES button 205 and a NO button 210, are displayed. When the driver touches the YES button 205, the ECU 20 starts the automatic parking control. When the driver touches the NO button 210, the ECU 20 does not start the automatic parking control and terminates displaying the availability screen 200. The YES button 205, which is operated to start the automatic parking control, is displayed on the availability screen 200. Therefore, when the position of the vehicle VA satisfies the start position condition and the vehicle speed Vs becomes equal to or lower than the start speed Vst, the ECU 20 allows the automatic parking control to be executed. The start speed Vst may also be described as the vehicle speed Vs at which the automatic parking control is allowed to be executed (i.e. the automatic parking control becomes available).

On the other hand, when the vehicle speed Vs is higher than the start speed Vst, the ECU 20 performs a deceleration notification to notify (inform) the driver that the automatic parking control becomes available if the vehicle VA is decelerated. For example, the ECU 20 displays a deceleration screen 220 on the display device 52. On the deceleration screen 220, a message such as “Please decelerate to start automatic parking.” is displayed. If, after the deceleration notification, the vehicle VA decelerates and the vehicle speed Vs becomes equal to or lower than the start speed Vst, and the position of the vehicle VA satisfies the start position condition, then the ECU 20 performs the availability notification.

By performing the deceleration notification, the driver can recognize that the automatic parking control cannot be started due to the fact that the vehicle speed Vs is higher than the start speed Vst, and that the automatic parking control becomes available if the vehicle VA is decelerated. Furthermore, by performing the availability notification, the driver can recognize that the automatic parking control becomes available. Accordingly, the present apparatus 10 can reduce the probability that an opportunity to execute the automatic parking control is lost.

### (Specific Operation)

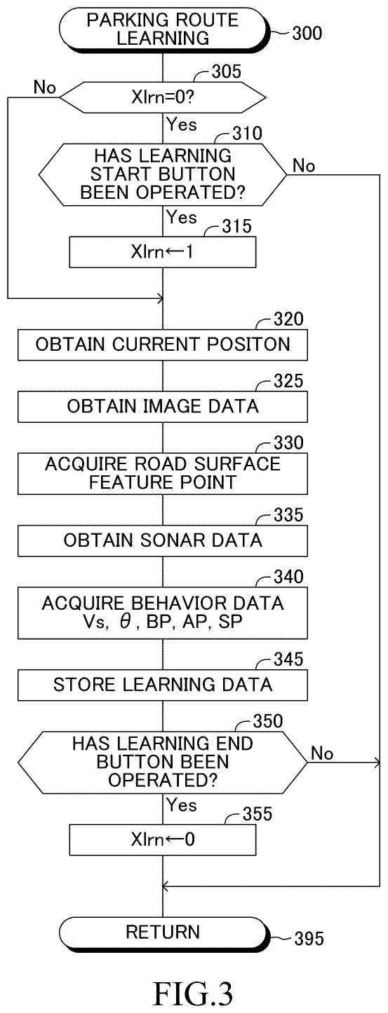

The CPU of the ECU 20 executes routines shown in flowcharts in FIG. 3 to FIG. 5 and FIG. 7, each time a predetermined time has elapsed.

### <Parking Route Learning Routine>

When an appropriate time comes, the CPU starts a process from step 300 in FIG. 3, and the process proceeds to step 305. At step 305, the CPU determines whether or not a learning flag Xlrn is “0”.

The learning flag Xlrn is set to “1” when the teaching drive is performed, and is set to “0” when the teaching drive is not performed. The learning flag Xlrn is set to “0” in an initialization routine. The initialization routine is executed by the CPU when an ignition key switch (not shown) of the vehicle VA is switched from an OFF position to an ON position.

If the learning flag Xlrn is “0”, the CPU makes a “Yes” determination at step 305, and the process proceeds to step 310. At step 310, the CPU determines whether or not a learning start button (not shown) has been operated.

If the learning start button has not been operated, the CPU makes a “No” determination at step 310. Thereafter, the process proceeds to step 395, and the CPU tentatively terminates the present routine.

If the learning button has been operated, the CPU makes a “Yes” determination at step 310, and executes steps 315 to 350.

Step 315: The CPU sets the learning flag Xlrn to “1.”

Step 320: The CPU obtains the current position (Xn, Yn) of the vehicle VA from the GNSS receiver 36.

Step 325: The CPU obtains the image data from the camera 22.

Step 330: The CPU identifies an image of a road surface from the image data and acquires a road surface feature point FPn, which is a feature point of the road surface. The CPU acquires the feature point using a known method. For example, this method is described in Japanese Patent Application Laid-Open No. 2022-133230.

Step 335: The CPU obtains the sonar data SDn from the sonar 24.

Step 340: The CPU acquires behavior data BD representing the behavior of the vehicle VA.

As an example, the behavior data BD includes the vehicle speed Vs, steered angle θ, accelerator operation amount AP, brake operation amount BP, and shift position SP.

Step 345: The CPU stores the current position (Xn, Yn) of the vehicle VA, the road surface feature point FPn, the sonar data SDn, and the behavior data BDn as learning data in the learning data storage section 54a.

Step 350: The CPU determines whether or not a learning end button (not shown) has been operated. The driver operates the learning end button when parking of the vehicle VA in the parking space PS is completed during the teaching drive.

If the learning end button has not been operated, the CPU makes a “No” determination at step 350. Thereafter, the process proceeds to step 395, and the CPU tentatively terminates the present routine.

If the learning flag Xlrn is “1” when the process proceeds to step 305, the CPU makes a “No” determination at step 305, and the process proceeds to step 320.

If the learning end button has been operated when the process proceeds to step 350, the CPU makes a “Yes” determination at step 350, and the process proceeds to step 355. At step 355, the CPU sets the learning flag Xlrn to “0”. Thereafter, the process proceeds to step 395, and the CPU tentatively terminates the present routine.

The CPU may set the learning flag Xlrn to “0” when the set position SP has been changed to the parking position (P range).

### <Notification Routine>

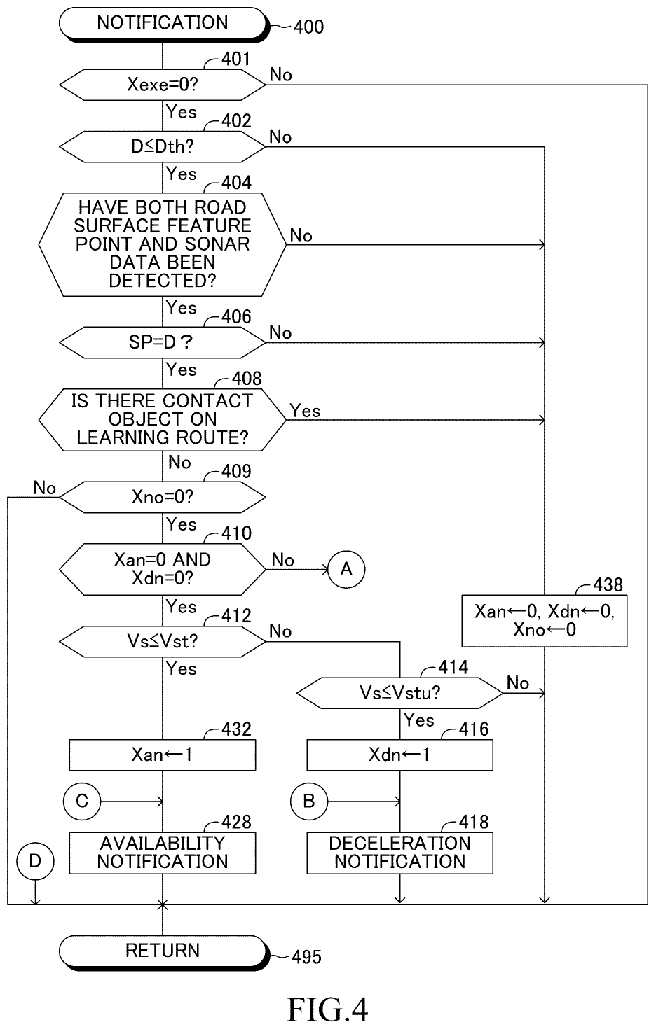

When an appropriate time comes, the CPU starts a process from step 400 of FIG. 4, and the process proceeds to step 401. At step 401, the CPU determines whether or not an execution flag Xexe is “0”.

The execution flag Xexe is set to “1” when the automatic parking control is executed, and is set to “0” when the automatic parking control is not executed. The execution flag Xexe is set to “0” in the initialization routine.

If the execution flag Xexe is “1”, the CPU makes a “No” determination at step 401. Thereafter, the process proceeds to step 495, and the CPU tentatively terminates the present routine. On the other hand, if the execution flag Xexe is “0”, the CPU makes a “Yes” determination at step 401, and the process proceeds to step 402.

At step 402, the CPU determines whether or not the distance D is equal to or shorter than the threshold distance Dth. More specifically, the CPU acquires the distance D based on the current position of the vehicle VA at the present time identified by the GNSS receiver 36 and the position of the vehicle VA included in the learning data stored in the learning data storage section 54a.

If the distance D is equal to or shorter than the threshold distance Dth, the CPU makes a “Yes” determination at step 402, and the process proceeds to step 404. At step 404, the CPU determines whether or not both the road surface feature point and the sonar data included in the learning data have been detected. Specifically, the CPU compares the “road surface feature point acquired based on the image data at the present time” with the road surface feature point included in the learning data to determine whether or not the road surface feature point included in the learning data has been detected. Similarly, the CPU compares the sonar data acquired at the present time with the sonar data included in the learning data to determine whether or not the sonar data included in the learning data has been detected.

If the road surface feature point at the present time matches the road surface feature point included in the learning data, and the sonar data at the present time matches the sonar data included in the learning data, the CPU determines that the position of the vehicle VA satisfies the start position condition. In this case, the CPU makes a “Yes” determination at step 404, and the process proceeds to step 406. At step 406, the CPU determines whether or the set position SP of the shift lever at the present time is the forward position (D range).

If the set position SP is the forward position (D range), the CPU makes a “Yes” determination at step 406, and the process proceeds to step 408. At step 408, the CPU recognizes an object based on the image data and the sonar data, and determines whether or not there is a contact object that comes into contact with the vehicle VA on the learning parking route Rpa.

If there is no contact obstacle on the learning parking route Rpa, the CPU makes a “No” determination at step 408, and the process proceeds to step 409. At step 409, the CPU determines whether or not a No flag Xno is “1”.

The No flag Xno is set to “1” when the NO button 210 on the availability screen 200 has been operated, and is set to “0” when the CPU makes a “No” determination at any of steps 402 to 406 or when the CPU makes a “Yes” determination at step 408. The No flag Xno is set to “0” in the initialization routine.

If the No flag Xno is “0”, the CPU makes a “Yes” determination at step 409, and the process proceeds to step 410. At step 410, the CPU determines whether or not both an availability notification flag Xan and a deceleration notification flag Xdn are “0”.

The availability notification flag Xan is set to “1” when the availability notification is started, and is set to “0” when the availability notification is ended. The availability notification flag Xan is set to “0” in the initialization routine.

The deceleration notification flag Xdn is set to “1” when the deceleration notification is started, and is set to “0” when the deceleration notification is ended. The deceleration notification flag Xdn is set to “0” in the initialization routine.

If both the availability notification flag Xan and the deceleration notification flag Xdn are “0”, the CPU makes a “Yes” determination at step 410, and the process proceeds to step 412. At step 412, the CPU determines whether or not the vehicle speed Vs is equal to or lower than the start speed Vst.

If the vehicle speed Vs is higher than the start speed Vst, the CPU makes a “No” determination at step 412, and the process proceeds to step 414. At step 414, the CPU determines whether or not the vehicle speed Vs is equal to or lower than an upper start limit speed Vstu, which is higher than the start speed Vst.

If the vehicle speed Vs is higher than the upper start limit speed Vstu, the CPU makes a “No” determination at step 414. Thereafter, the process proceeds to step 495, and the CPU tentatively terminates the present routine. As a result, when the vehicle speed Vs exceeds the upper start limit speed Vstu, the deceleration notification is not performed.

If the vehicle speed Vs is equal to or lower than the upper start limit speed Vstu (that is, if the vehicle speed Vs is higher than the start speed Vst and equal to or lower than the upper start limit speed Vstu), the CPU makes a “Yes” determination at step 414 and executes steps 416 and 418.

Step 416: The CPU sets the deceleration notification flag Xdn to “1”.

Step 418: The CPU performs the deceleration notification.

Thereafter, the process proceeds to step 495, and the CPU tentatively terminate the present routine.

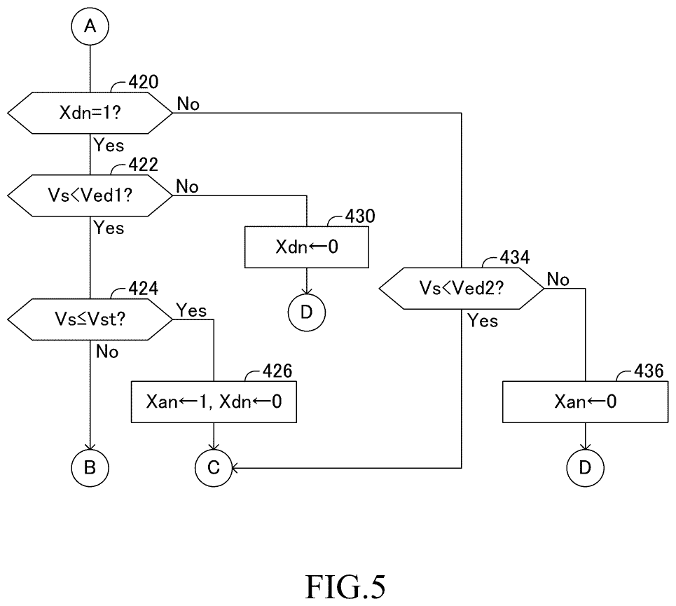

If at least one of the availability notification flag Xan or the deceleration notification flag Xdn is “1” when the process proceeds to step 410, the CPU makes a “No” determination at step 410, and the process proceeds to step 420 shown in FIG. 5. At step 420, the CPU determines whether or not the deceleration notification flag Xdn is “1”.

If the deceleration notification flag Xdn is “1”, the CPU makes a “Yes” determination at step 420, and the process proceeds to step 422. At step 422, the CPU determines whether or not the vehicle speed Vs is lower than a first end speed Ved1, which is higher than the upper start limit speed Vstu. If the vehicle speed Vs is lower than the first end speed Ved1, the CPU makes a “Yes” determination at step 422, and the process proceeds to step 424.

At step 424, the CPU determines whether or not the vehicle speed Vs is equal to or lower than the start speed Vst. If the vehicle speed Vs is higher than the start speed Vst, the CPU makes a “No” determination at step 424, and the process proceeds to step 418 shown in FIG. 4. As a result, the CPU performs the deceleration notification. If the driver decelerates the vehicle VA in response to the deceleration notification and the vehicle speed Vs becomes equal to or lower than the start speed Vst, the CPU makes a “Yes” determination at step 424 shown in FIG. 5, and the process proceeds to step 426. At step 426, the CPU sets the availability notification flag Xan to “1” and the deceleration notification flag Xdn to “0”. Thereafter, the process proceeds to step 428 shown in FIG. 4. At step 428, the CPU performs the availability notification. Thereafter, the process proceeds to step 495, and the CPU tentatively terminates the present routine.

If the vehicle speed Vs is equal to or higher than the first end speed Ved1 when the process proceeds to step 422 shown in FIG. 5, the CPU makes a “No” determination at step 422, and the process proceeds to step 430. At step 430, the CPU sets the deceleration notification flag Xdn to “0”. Thereafter, the process proceeds to step 495 shown in FIG. 4, and the CPU tentatively terminates the present routine. If the vehicle speed Vs becomes equal to or higher than the first end speed Ved1 after the deceleration notification, it is likely that the driver does not intend to use the automatic parking control. Therefore, if the vehicle speed Vs becomes equal to or higher than the first end speed Ved1, the CPU ends the deceleration notification.

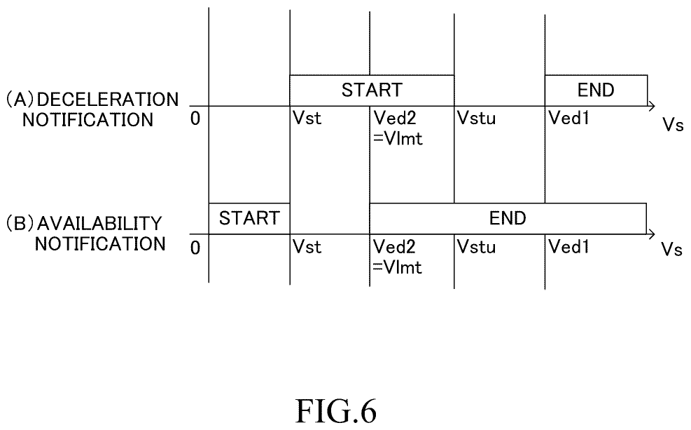

As shown in FIG. 6(A), if the vehicle speed Vs is higher than the start speed Vst and equal to or lower than the upper start limit speed Vstu, the deceleration notification is started. Once the deceleration notification is started, the deceleration notification is ended when the vehicle speed Vs becomes equal to or higher than the first end speed Ved1.

If the vehicle speed Vs is equal to or lower than the start speed Vst when the process proceeds to step 412 shown in FIG. 4 and, the CPU makes a “Yes” determination at step 412, and the process proceeds to step 432. At step 432, the CPU sets the availability notification flag Xan to “1”. Thereafter, the process proceeds to step 428, and the CPU performs the availability notification.

If the deceleration notification flag Xdn is “0” when the process proceeds to step 420 shown in FIG. 5, at least one of the availability notification flag Xan and the deceleration notification flag Xdn is “1”. This is because, when the CPU makes a “No” determination at step 410 shown in FIG. 4, the process proceeds to step 420. Since both the availability notification flag Xan and the deceleration notification flag Xdn are never simultaneously set to “1”, if the deceleration notification flag Xdn is “0”, then the availability notification flag Xan is “1”. If the deceleration notification flag Xdn is “0” (that is, if the availability notification flag Xan is “1”), the CPU makes a “No” determination at step 420 shown in FIG. 5, and the process proceeds to step 434.

At step 434, the CPU determines whether or not the vehicle speed Vs is lower than a second end speed Ved2. The second end speed Ved2 is higher than the start speed Vst and lower than the upper start limit speed Vstu. In the present embodiment, the second end speed Ved2 is set to an upper control limit speed Vlmt, which will be described later. If the vehicle speed Vs is lower than the second end speed Ved2, the CPU makes a “Yes” determination at step 434, and the process proceeds to step 428 shown in FIG. 4. As a result, the CPU performs the availability notification.

If the vehicle speed Vs is equal to or higher than the second end speed Ved2, the CPU makes a “No” determination at step 434 shown in FIG. 5, and the process proceeds to step 436. At step 436, the CPU sets the availability notification flag Xan to “0”. Thereafter, the process proceeds to step 495 shown in FIG. 4, and the CPU tentatively terminates the present routine. When the present routine is executed again after the availability notification is ended and the process proceeds to step 410, the process proceeds to step 412. Thereafter, if the vehicle speed Vs is higher than the start speed Vst and equal to or lower than the upper start limit speed Vstu, the deceleration notification is started.

As shown in FIG. 6(B), if the vehicle speed Vs is equal to or lower than the start speed Vst, the availability notification is started. Once started, the availability notification is ended when the vehicle speed Vs becomes equal to or higher than the second end speed Ved2.

If the distance D is longer than the threshold distance Dth (“No” at step 402 shown in FIG. 4), the road surface feature point and the sonar data do not match the learning data (“No” at step 404), the set position SP is not the forward position (D range) (“No” at step 406), or there is the contact obstacle (“Yes” at step 408), the process proceeds to step 438. At step 438, the CPU sets the availability notification flag Xan, the deceleration notification flag Xdn, and the No flag Xno to “0”. Thereafter, the process proceeds to step 495, and the CPU tentatively terminates the present routine.

If the process proceeds to step 409 and the No flag Xno is “1”, the CPU makes a “Yes” determination at step 409. Thereafter, the process proceeds to step 495, and the CPU tentatively terminates the present routine.

### <Automatic Parking Control Routine>

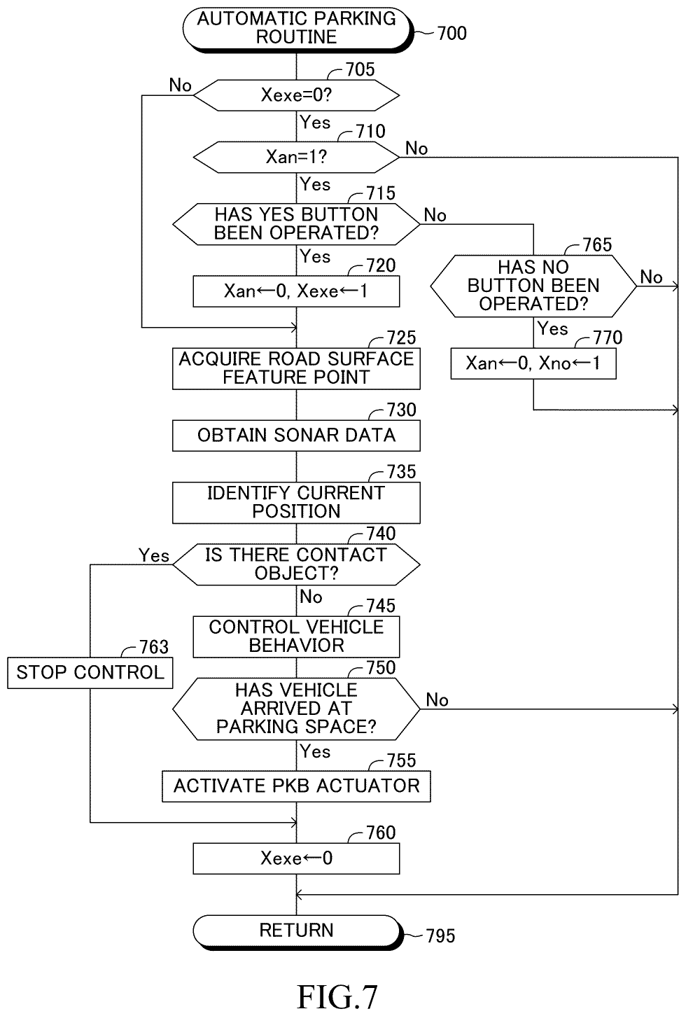

When an appropriate time comes, the CPU starts a process from step 700 in FIG. 7, and the process proceeds to step 705. At step 705, the CPU determines whether or not the execution flag Xexe is “0”.

If the execution flag Xexe is “0”, the CPU makes a “Yes” determination at step 705, and the process proceeds to step 710. At step 710, the CPU determines whether or not the availability notification flag Xan is “1”.

If the availability notification flag Xan is “0”, the CPU makes a “No” determination at step 710. Thereafter, the process proceeds to step 795, and the CPU tentatively terminates the present routine.

If the availability notification flag Xan is “1”, the CPU makes a “Yes” determination at step 710, and the process proceeds to step 715. At step 715, the CPU determines whether or not the YES button 205 on the availability screen 200 has been operated.

If the YES button 205 has been operated, the CPU makes a “Yes” determination at step 715, and executes steps 720 to 740.

Step 720: The CPU sets the availability notification flag Xan to “0” and the execution flag Xexe to “1”.

Because the availability notification flag Xan is set to “0” when the YES button 205 has been operated, the availability notification is ended.

Step 725: The CPU obtains the image data from the camera 22 and acquires (extracts) the road surface feature point from the image data.

Step 730: The CPU obtains the sonar data from the sonar 24.

Step 735: The CPU identifies the current position of the vehicle VA with respect to the learning parking route Rpa by comparing the road surface feature point acquired at step 725 with the learning data and by comparing the sonar data obtained at step 730 with the learning data.

Step 740: The CPU determines whether or not there is the contact object (obstacle) on the learning parking route Rpa along which the vehicle VA is about to travel.

When there is no obstacle, the CPU makes a “No” determination at step 740, and the process proceeds to step 745. At step 745, the CPU controls a traveling state of the vehicle VA so that the vehicle speed Vs does not exceed the upper limit control vehicle speed Vlmt, the behavior of the vehicle VA matches the behavior data of the learning data, and the vehicle VA travels along the learning parking route Rpa.

A control of step 745 is divided into a control of acceleration and deceleration of the vehicle VA, a control of the steered angle θ, and a control of the shift lever position SP. These controls will be described below.

First, the CPU identifies the learning data corresponding to the current position of the vehicle VA with respect to the learning parking route Rpa. This learning data is hereinafter referred to as the “corresponding learning data”.

### <Acceleration and Deceleration>

The CPU acquires a target acceleration Gtgt such that the vehicle speed Vs does not exceed the upper limit control vehicle speed Vlmt and the vehicle speed Vs matches the vehicle speed Vs of the corresponding learning data. The CPU controls the powertrain actuator 40 and the brake actuator 42 so that the acceleration G of the vehicle VA matches the target acceleration Gtgt. When the accelerator operation amount AP of the corresponding learning data is equal to or greater than a threshold amount APth, the CPU may increase the acquired target acceleration Gtgt. When the brake operation amount BP is equal to or greater than a threshold amount BPth, the CPU may decrease the acquired target acceleration Gtgt.

### <Steered Angle>

The CPU acquires a target steered angle θtgt for the vehicle VA to travel along the learning parking route Rpa. The CPU controls the steering motor 44 so that the steered angle θ matches the target steered angle θtgt.

### <Shift Lever Position SP>

If the current shift position SP differs from the shift position SP of the corresponding learning data, the CPU controls the shift actuator 50 so that the shift position SP matches the shift position SP of the corresponding learning data.

Thereafter, the process proceeds to step 750, and the CPU determines whether or not the vehicle VA has arrived at the parking space PS.

If the vehicle VA has not arrived at the parking space PS, the CPU makes a “No” determination at step 750. Thereafter, the process proceeds to step 795, and the CPU tentatively terminates the present routine.

On the other hand, if the vehicle VA has arrived at the parking space PS, the CPU makes a “Yes” determination at step 750 and executes steps 755 and 760. In the teaching drive, when parking is completed, the driver changes the shift lever position SP to the parking position (P range). Accordingly, when the vehicle VA has arrived at the parking space PS, the shift position SP is set to the parking position (P range) at step 745.

Step 755: The CPU activates the PKB actuator 48 to apply the parking brake force to the wheels.

Step 760: The CPU sets the execution flag Xexe to “0”.

Thereafter, the process proceeds to step 795, and the CPU tentatively terminates the present routine.

If the execution flag Xexe is “1” when the process proceeds to step 705, the CPU makes a “No” determination at step 705, and the process proceeds to step 725.

If there is the contact object when the process proceeds to step 740, the CPU makes a “Yes” determination at step 740, and the process proceeds to step 763. At step 763, the CPU decelerates the vehicle VA in order to stop the vehicle VA. Thereafter, the process proceeds to step 760.

If the YES button 205 has not been operated when the process proceeds to step 715, the CPU makes a “No” determination at step 715, and the process proceeds to step 765. At step 765, the CPU determines whether or not the NO button 210 has been operated.

If the NO button 210 has been operated, the CPU makes a “Yes” determination at step 765, and the process proceeds to step 770. At step 770, the CPU sets the availability notification flag Xan to “0” and sets the No flag Xno to “1”. Thereafter, the process proceeds to step 795, and the CPU tentatively terminates the present routine.

On the other hand, if the NO button 210 has not been operated, the CPU makes a “No” determination at step 765. Thereafter, the process proceeds to step 795, and the CPU tentatively terminates the present routine.

### <Deceleration Notification>

The deceleration notification is summarized below.

When the position of the vehicle VA satisfies the start position condition and the vehicle speed Vs is higher than the start speed Vst and equal to or lower than the upper start limit speed Vstu (see FIG. 6(A)), the deceleration notification is started.

As a result, the present apparatus 10 can inform the driver that the automatic parking control becomes available if the vehicle VA is decelerated. Accordingly, the present apparatus 10 can reduce the possibility that the opportunity to execute the automatic parking control is lost. Furthermore, when the vehicle speed Vs is higher than the upper start limit speed Vstu, it is likely that the driver does not intend to use the automatic parking control. If the deceleration notification is performed despite the driver not intending to use the automatic parking control, the driver may find the deceleration notification annoying. Accordingly, the present apparatus 10 does not start the deceleration notification when the vehicle speed Vs is higher than the upper start limit speed Vstu (see FIG. 6(A)).

As shown in FIG. 6(A), once the deceleration notification is started, the deceleration notification is ended when the vehicle speed Vs becomes equal to or higher than the first end speed Ved1, since it is likely that the driver has already lost the intention to use the automatic parking control when the vehicle speed Vs becomes equal to or higher than the first end speed Ved1.

### <Availability Notification>

When the position of the vehicle VA satisfies the start position condition and the vehicle speed Vs is equal to or lower than the start speed Vst, the availability notification is started (see FIG. 6(B)). As a result, the present apparatus 10 can notify (inform) the driver that the automatic parking control is available. Therefore, the present apparatus 10 can reduce the probability that the opportunity to execute the automatic parking control is lost.

Once the availability notification is started, the availability notification is ended when the vehicle speed Vs becomes equal to or higher than the second end speed Ved2 (see FIG. 6(B)). The second end speed Ved2 is set to the same value as the upper limit control vehicle speed Vlmt. Furthermore, when the availability notification is not being performed, the driver cannot operate the YES button 205, and therefore the automatic parking control is not started. As a result, the present apparatus 10 can prevent the automatic parking control from being started when the vehicle speed Vs is equal to or higher than the upper limit control vehicle speed Vlmt.

The present disclosure is not limited to the above-described embodiment, and various modifications may be made within the scope of the present disclosure.

### First Modification

The parking support control to which the present disclosure is applicable is not limited to a learning-type automatic parking control in which the vehicle VA is parked based on the previously learned learning parking route Rpa as described in the above embodiment. The present disclosure is also applicable to a search-type automatic parking control. In the search-type automatic parking control, the ECU 20 searches for the parking space PS in which the vehicle VA can be parked based on the image data and the sonar data, and automatically parks the vehicle VA in the detected parking space PS.

In the search-type automatic parking control, when the ECU 20 detects a parking space PS, the ECU 20 generates a parking route Rpa to the parking space PS. Upon detecting the parking space PS, the ECU 20 determines that the position of the vehicle VA satisfies the start position condition and determines whether or not the vehicle speed Vs is equal to or lower than the start speed Vst. If the vehicle speed Vs is equal to or lower than the start speed Vst, the ECU 20 performs the availability notification. If the vehicle speed Vs is higher than the start speed Vst and equal to or lower than the upper start limit speed Vstu, the ECU 20 performs the deceleration notification. Note that, when the YES button 205 is operated while the availability notification is being performed, the ECU 20 starts automatically driving the vehicle VA toward the parking space PS.

Furthermore, the present disclosure is applicable not only to the automatic parking control but also to a suggestion-based support control. In the suggestion-based support control, the ECU 20 provides a suggestion to the driver regarding a driving operation required to park the vehicle VA in the parking space PS. For example, the ECU 20 may suggest a steering angle of the steering wheel for enabling the vehicle VA to travel along a parking route Rpa. The suggestion-based assistance control is applicable to both the learning-type control and the search-type control. If the position of the vehicle VA satisfies the start position condition and the vehicle speed Vs is equal to or lower than the start speed Vst, the availability notification is performed. If the position of the vehicle VA satisfies the start position condition and the vehicle speed Vs is higher than the start speed Vst and equal to or shorter than the upper start limit speed Vstu, the deceleration notification is performed.

### Second Modification

In the above embodiment, the second end speed Ved2 is set to the upper limit control vehicle speed Vlmt, however, the start speed Vst may be set to the upper limit control vehicle speed Vlmt. The ECU 20 performs the availability notification when the vehicle speed Vs is equal to or lower than the start speed Vst, and ends the availability notification when the vehicle speed Vs is higher than the start speed Vst.

### Third Modification

In the above embodiment, the ECU 20 determines that the position of the vehicle VA satisfies the start position condition when all of the following conditions are satisfied.

A first condition is satisfied when the distance D between the vehicle VA and the learning parking route Rpa is equal to or shorter than the threshold distance Dth.

A second condition is satisfied when the road surface feature point included in the learning data is detected.

A third condition is satisfied when the sonar data included in the learning data is detected.

The ECU 20 may determine that the position of the vehicle VA satisfies the start position condition when at least the first condition is satisfied, or when at least one of the first through third conditions is satisfied.

The ECU 20 may determine that the first condition is satisfied when a distance Da between the vehicle VA and the parking space PS is equal to or shorter than a threshold distance Dath. Note that, as described above, in the search-type automatic parking control and the search-type suggestion control, when the parking space PS is detected, the ECU 20 determines that the position of the vehicle satisfies the start position condition.

### Fourth Modification

The deceleration notification and the availability notification are not limited to a manner in which a screen is displayed. In the deceleration notification and the availability notification, a voice message may be output from a speaker (not shown).

A start operation for starting the parking support control is not limited to an operation of the YES button 205. For example, if the driver provides a voice input for starting the parking support control during a period from the start to the end of the availability notification, or operates a start button (not shown), the parking support control may be started.

The present apparatus 10 may be applied to (or installed in/on) an engine vehicle, a hybrid electric vehicle (HEV), a plug-in hybrid electric vehicle (PHEV), a fuel cell electric vehicle (FCEV), and a battery electric vehicle (BEV).

What is claimed is:

1. A parking support apparatus configured to execute a parking support control for parking a vehicle in a parking space,
wherein,
the parking support apparatus is configured to:
allow the parking support control to be executed, in response to a position of the vehicle satisfying a start position condition and a vehicle speed being equal to or lower than a predetermined start speed; and
start a deceleration notification that notifies a user that the parking support control becomes available by decelerating the vehicle, in response to the position of the vehicle satisfying the start position condition and the vehicle speed being higher than the start speed.

2. The parking support apparatus according to claim 1,
wherein,
the parking support apparatus is configured to start an availability notification that notifies the user that the parking support control is available, in response to the position of the vehicle satisfying the start position condition and the vehicle speed being equal to or lower than the start speed.

3. The parking support apparatus according to claim 1,
wherein,
the parking support apparatus is configured to:
determine whether or not the vehicle speed is equal to or lower than a start upper-limit speed that is greater than the start speed, in response to the position of the vehicle satisfying the start position condition and the vehicle speed being higher than the start speed;
start the deceleration notification in response to the vehicle speed being equal to or lower than the start upper-limit speed;
not start the deceleration notification in response to the vehicle speed being higher than the start upper-limit speed; and
end the deceleration notification in response to the vehicle speed becoming equal to or higher than a first end speed that is higher than the start upper-limit speed after the deceleration notification has been started.

4. The parking support apparatus according to claim 2,
wherein the parking support apparatus is configured to execute, as the parking support control, an automatic parking control for automatically driving the vehicle to park the vehicle in the parking space such that the vehicle speed does not exceed an upper-limit control speed, and
wherein the start speed is set to the upper-limit control speed.

5. The parking support apparatus according to claim 2,
wherein,
the parking support apparatus is configured to:
start, as the parking support control, an automatic parking control for automatically driving the vehicle to park the vehicle in the parking space such that the vehicle speed does not exceed an upper-limit control speed, in response to a predetermined start operation being performed by the user while the availability notification is being performed;
end the availability notification in response to the vehicle speed becoming equal to or higher than a second end speed that is higher than the start speed; and
wherein the second end speed is set to the upper-limit control speed.

6. The parking support apparatus according to claim 1,
wherein,
the parking support apparatus is configured to:
store, as a learning parking route, a route that the vehicle traveled along when the vehicle was parked in the parking space by manual driving;
execute, as the parking support control, an automatic parking control for automatically driving the vehicle along the learning parking route to park the vehicle in the parking space; and
determine that the position of the vehicle satisfies the start position condition in response to a distance between the vehicle and the learning parking route being equal to or shorter than a threshold distance.

7. The parking support apparatus according to claim 1,
wherein,
the parking support apparatus is configured to:
execute, as the parking support control, an automatic parking control for automatically driving the vehicle to park the vehicle in the parking space; and
start the deceleration notification in response to:
the position of the vehicle satisfying the start position condition,
the vehicle speed being higher than the start speed, and
there being no contact object that may come into contact with the vehicle on a planned route along which the vehicle is to travel in order to park in the parking space.
